(19) United States
(12) Patent Application Publication
(10) Pub. No.: US 2016/0289468 A1
(43) Pub. Date: Oct. 6, 2016

(54) High-Density Compounds for 3D Printing

(71) Applicant: TURNER INNOVATIONS, Orem, UT (US)

(72) Inventor: D. Clark Turner, Payson, UT (US)

(21) Appl. No.: 15/037,970

(22) PCT Filed: Nov. 21, 2014
(86) PCT No.: PCT/US2014/066769

§ 371 Date: May 19, 2016

Related U.S. Application Data
(60) Provisional application No. 61/907,842, filed on Nov. 22, 2013.

(51) Int. Cl. C09D 7/12; D01F 1/10; C09D 5/00; B29C 67/00; B33Y 70/00; B33Y 10/00; B33Y 80/00; D01F 6/42; C09D 155/02

(52) U.S. Cl. CPC C09D 7/1216; D01F 6/42; D01F 1/106; C09D 5/00; C09D 155/02; B33Y 70/00; B33Y 10/00; B33Y 80/00; B29C 67/0055; C08K 3/22

(57) ABSTRACT

High density compounds that can be used in extrusion-based 3D printing processes and methods for making the same are described. The high-density compounds can be made in the form of filaments by providing a thermoplastic material (such as ABS), providing a source of heavy metal (such as Bi₂O₃ powder), compounding the thermoplastic material and the heavy metal source to form high-density compound, and then extruding the high-density compound to form the filament shape. These filaments can be used to make a high-density product by melting the filaments in the printing head of a FDM 3D printer and then depositing the molten material in the 3D printer in successive layers to form the high-density product. The resulting high-density products exhibit an enhanced radiopacity because of the presence of the heavy metal, allowing the rapid manufacturing of radiation shielding components via the 3D printing process. Other embodiments are described.

### FIELD

This application relates generally to high-density compounds. In particular, this application relates to high-density compounds in the form of filaments that can be used in extrusion-based 3D printing processes, such as fused deposition modeling (FDM).

### BACKGROUND

Additive manufacturing or three-dimensional (3D) printing is a process of making a three-dimensional solid object of virtually any shape from a digital model. 3D printing is achieved using an additive process, where successive layers of material are laid down in different shapes. 3D printing is considered distinct from traditional machining techniques, which mostly rely on the removal of material by methods such as cutting or drilling (often referred to as subtractive processes). 3D printing allows a user to design, form, and test a component relatively quickly and inexpensively by allowing the prototype part to be printed in minutes or hours and then tested for fit and sometimes function. Objects that are manufactured additively can be used anywhere throughout the product life cycle, from pre-production (i.e. rapid prototyping) to full-scale production (i.e. rapid manufacturing), in addition to tooling applications and post-production customization.

### SUMMARY

This application relates to high-density compounds that can be used in extrusion-based 3D printing processes and methods for making the same. The high-density compounds can be made in the form of filaments by providing a thermoplastic material (such as ABS), providing a source of heavy metal (such as Bi₂O₃ powder), compounding the thermoplastic material and the heavy metal source to form a high-density compound, and then extruding the high-density compound to form the filament shape. These filaments can be used to make a high-density product by melting the filaments in the printing head of a FDM 3D printer and then depositing the molten material in the 3D printer in successive layers to form the high-density product. The resulting high-density products exhibit an enhanced radiopacity because of the presence of the heavy metal, allowing the rapid manufacturing of radiation shielding components via the 3D printing process.

### BRIEF DESCRIPTION OF THE DRAWINGS

The following description can be better understood in light of the Figures, in which:

FIG. 1 shows some embodiments of methods for making 3D printed high-density products using high-density filaments containing a thermoplastic material and a heavy metal component.

The Figures illustrate specific aspects of the high-density compounds that can be used in extrusion-based 3D printing processes. Together with the following description, the Figures demonstrate and explain the principles of the structures, methods, and principles described herein. In the drawings, the thickness and size of components may be exaggerated or otherwise modified for clarity. The same reference numerals in different drawings represent the same element, and thus their descriptions will not be repeated. Furthermore, well-known structures, materials, or operations are not shown or described in detail to avoid obscuring aspects of the described devices. Moreover, for clarity, the Figures may show simplified or partial views, and the dimensions of elements in the Figures may be exaggerated or otherwise not in proportion.

### DETAILED DESCRIPTION

The following description supplies specific details in order to provide a thorough understanding. Nevertheless, the skilled artisan would understand that the described systems and methods for systems can be implemented and used without employing these specific details. Indeed, the described systems and methods can be placed into practice by modifying the illustrated devices and methods and can be used in conjunction with any other apparatus and techniques conventionally used in the industry. For example, while the description below focuses on high-density compounds used for FDM 3D printing, they can be used in other 3D printing methods like stereolithography (SLA). Indeed, the high-density compounds can be used in other end uses like weighting and balancing applications such as golf clubs and tennis rackets.

As the terms on, attached to, connected to, or coupled to are used herein, one object (e.g., a material, an element, a structure, etc.) can be on, attached to, connected to, or coupled to another object, regardless of whether the one object is directly on, attached, connected, or coupled to the other object or whether there are one or more intervening objects between the one object and the other object. Also, directions (e.g., on top of, below, above, top, bottom, side, up, down, under, over, upper, lower, horizontal, vertical, etc.), if provided, are relative and provided solely by way of example and for ease of illustration and discussion and not by way of limitation. Where reference is made to a list of elements (e.g., elements a, b, c), such reference is intended to include any one of the listed elements by itself, any combination of less than all of the listed elements, and/or a combination of all of the listed elements. Further, the terms a, an, and one may each be interchangeable with the terms at least one and one or more.

The high-density compounds described in this application can be prepared by mixing a thermoplastic material with a heavy metal source so that the resulting compound contains a heavy metal component. Examples of thermoplastic materials that can be used include acrylonitrile-butadiene-styrene terpolymer (ABS), polycarbonate (PC), poly(meth)acrylate, polyphenylene sulphone (PPSU), high density polyethylene HDPE, polyetherimide (PEI), polyether ether ketone (PEEK), polylactic acid (PLA), nylon, polystyrene, as well as homopolymers, copolymers, and ionomers thereof, and combinations of any of these materials. Methacrylate can include both methacrylate (e.g., methyl methacrylate, ethyl methacrylate, etc.), acrylates (e.g., ethylhexyl acrylate, ethyl acrylate, etc.), or a mixture of the two. In some embodiments, the thermoplastics material used to make the high-density compound comprises ABS.

The high-density compounds also contain a heavy metal component. The heavy metal component(s) is used so that the resulting compounds exhibit a high density and are also opaque to radiation. In some embodiments, the radiopacity of the compounds can depend on the atomic number, or Z-value, of the heavy metal component which can also be used to increase density of the resulting compounds. A denser material with a higher Z-value provides better radiopacity for high energy x-rays and gamma rays. Accordingly, in some embodiments, the high-density compound& contains a high-Z metal, such as bismuth (Bi), iodine (I), barium, tin, tantalum, cesium, antimony, gold, tungsten, as well as oxides, nitrides, or alloys thereof.

In some configurations, the high-density compounds contain bismuth as the heavy metal component. Bismuth may be used in the high-density compounds instead of lead (which is often used in high-density products) because bismuth is considered one of the less toxic of the heavy metals and provides comparable radiation shielding to lead. As well, there exist a wide range of functional bismuth sources and methods for making them, e.g., carboxylic acid monomers, radical polymerization capable co-monomers, cross linking agents, radical initiators, and non-covalently-bonded soluble bismuth sources that provide increased flexibility in both design and manufacturing and allows for a greater range of function and use when compared with lead or lead-based materials.

The use of high-Z metals (especially bismuth) in the high-density compounds, as opposed to lead, also offers numerous environmental, commercial, and application advantages. For example, while lead is subject to extremely strict environmental regulations, bismuth compounds are generally subject to less stringent controls. Also, while the ingestion of lead results in adverse consequences, the ingestion of a majority of the bismuth containing compounds does not.

Bismuth can be used since it is also relatively safe. This element is considered to have a low electrical and thermal conductivity, and is generally non-reactive and non-flammable. Furthermore, bismuth poses no hazardous or toxic waste disposal issues, requires no special handling procedures, thus lowering manufacturing costs especially when compared with lead compounds. Because the radiation shielding material contains no lead, significant savings in both cost and time may be realized, while avoiding the burdensome regulations related to lead. Lastly, because bismuth has a similar density to lead oxide, it can be used in place of lead in certain kinds/types of applications at a convenient 1:1 ratio.

The amount of thermoplastic material and the amount of the heavy metal component in the high-density compounds depend on which of these materials are actually used. When ABS is used as the thermoplastic material and bismuth is used as the heavy metal component, the high-density compounds that contain about 22 to about 30 wt % ABS and about 70 to about 78 wt % bismuth. In other embodiments that do not used these materials, the high-density compounds can contain about 15 to about 25 wt % thermoplastic material and about 75 to about 85 wt % heavy metal component. In yet other embodiments, the concentrations of these two components can be any combination or sub-range of these amounts.

Given that the density of the compounds can be an important feature, in some configurations the density of the thermoplastic material and the density of the source of the heavy metal can be selected to provide the desired density of the high-density compound. When ABS is used as the thermoplastic material, its density can be about 1 g/cm³. When Bi₂O₃ powder is used as the source of the heavy metal, the density of the Bi₂O₃ powder can be about 9 g/cm³. In yet other embodiments, the densities of these two components can be any combination or sub-range of these amounts.

Carefully selecting the density of the thermoplastic material and the density of the source of the heavy metal component helps control the final density of the high-density compound. In some embodiments, the density of the high-density compound can be above 6 g/cm³. In some embodiments, the density of the high-density compound can range from about 2 to about 6 g/cm³.

In addition to the thermoplastic material and heavy metal components, the high-density compounds can contain additives including colorants, adhesion promoters, cross-linking agents, fillers, binders, fibers, coatings, carbon nanotubes, nanoparticles, and other components that can be added to enhance the material properties of the high-density compounds. As examples, electrically insulating materials, strengthening materials, materials to provide a uniform composition or bind other components, and/or density increasing materials may be used. A more specific list of examples of the additives include such materials as barium sulfate, tungsten, other metals, calcium carbonate, hydrated alumina, tabular alumina, silica, glass beads, glass fibers, magnesium oxide, wollastonite, stainless steel fibers, copper, carbonyl iron, steel, iron, molybdenum, and/or nickel.

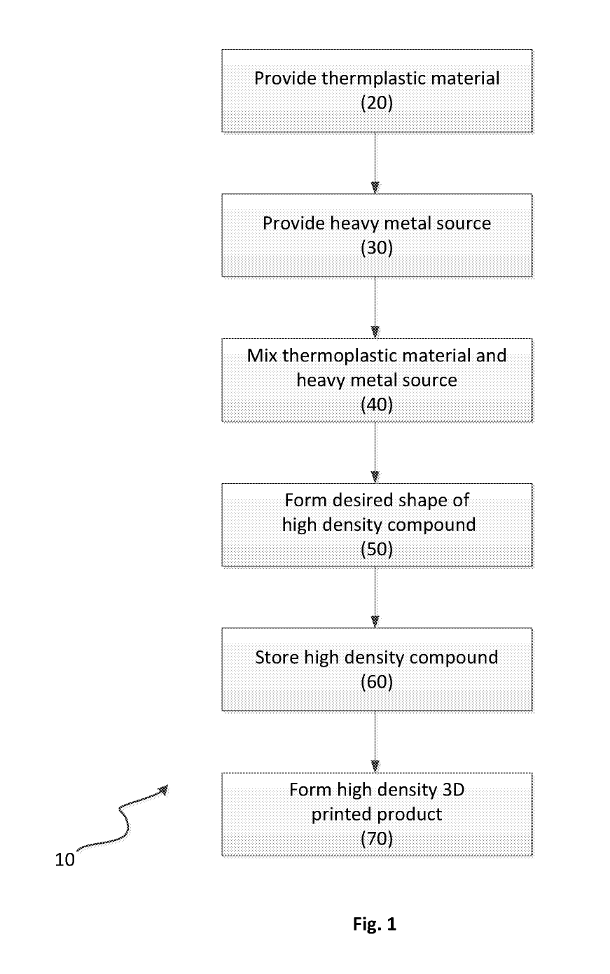

The high-density compounds can be formed using any method that provides the compounds with the features described herein. In some embodiments, the high-density compounds can be made by some of the method 10 illustrated in FIG. 1. Method 10 begins by providing the desired thermoplastic material, as noted in box 20, and the desired source of the heavy metal, as noted in box 30. In some embodiments, the thermoplastic material provided is ABS and the source of the heavy metal is Bi₂O₃ powder.

These two components, along with any other additive described herein, are then mixed together to form the high-density compound, as shown in box 40. In those embodiments where the thermoplastic material is ABS and the source of the heavy metal is Bi₂O₃ powder, these two components can be mixed by compounding. In the compounding process, the ABS is melted and then mixed with the Bi₂O₃powder (and any other additive) in a high shear mixing process for a time sufficient to compound the ABS and Bi₂O₃ together.

The high-density compounds can then be formed into any desired shape that can be used in the desired 3D printing method, as shown in box 50. Where the high-density compounds are used in FDM 3D printing, they can be formed into filaments by an extrusion process that extrudes the high-density compound into a filament. Optionally, the high-density compound can then be stored, as shown in box 60. Where the high-density compound is in the form of a filament, it can be-merely be spooled for storage.

When formed as filaments, the high-density compound can then be used in any appropriate extrusion-based 3D printing process, including a FDM printing process. In the FDM method, the filaments are melted in a nozzle and then printed selectively. This printing process is generally performed using a layer-by-layer process, as known in the art, to build any desired product that contains the compound. To make the desired product using the 3D printer, a desired design for the product may be created using software which allows a user to electronically draw and represent the desired product as a three-dimensional object in an electronic drawing. Such software is usually referred to as computer-aided-drafting or CAD software. The electronic drawing of the component may then be converted into instructions for the FDM 3D printer to create the component using the high density compound. For example, with an FDM 3D printer, the filaments may be fed into the nozzles of the printer and then melted in very small amounts using a FDM print head to build layers of the compound, melting each new layer onto previous layers, and eventually forming the layers into a finished product or even a manufactured part for use. In some configurations, other thermoplastic filaments (without the heavy metal) can be used in combination with the high-density filaments in the 3D printer to make products with portions having different densities. Similar extrusion-based 3D printing methods include fused filament fabrication (FFM), melted extrusion manufacturing (MEM) or selective deposition modelling (SDM).

In other embodiments, the high-density compounds can be used with SLA 3D printers. In these embodiments, a heavy metal compound is chemically bound to the polymer chain of a photosensitive resin. This bonding results in a compound that is suitable for use in SLA 3D printers where photopolymerization is used so that thin layers of photopolymers are exposed to light in a desired pattern, causing the photopolymer to harden.

The 3D printing process using the high-density compounds can be used to create virtually any product, as shown in box 70 of FIG. 1. In some configurations, the 3D printing process can be used to make products that are used for radiation shielding. Such products are known in the industry, but typically contain lead. Some exemplary radiation shielding products include x-ray tube shielding, collimators, grids, patient-specific shielding, patient specific modeling for surgical planning, and imaging phantoms that simulate human anatomy with a high-density section designed to simulate metal implants or other features that are added into the human anatomy. These products have traditionally been made from lead to provide protection and facilitate containment of harmful radiation. Because lead is extremely dense, inexpensive, and readily malleable, it can be a material of choice for shielding and other radiographic components. But lead is toxic and environmentally sensitive. And while the design, manufacturing and testing of lead or lead shielded components can be expensive and time consuming compared to modern 3D processes, many parts cannot be designed and tested using traditional 3D printing materials because of the penetration of the x-rays through the various materials used in 3D printing, which are not radiopaque. These parts instead require much older and much more expensive and inefficient prototyping and design techniques such as molding and machining. Using the methods and high density compounds described herein, however, allows the quick and easy construction of 3D printed materials which are radiopaque. In other embodiments, the 3D printing process can be used to make products that are used for weighting and balancing applications, such as inserts for golf clubs and tennis rackets and other sports equipment.

The high-density 3D printed products exhibit several features that make them attractive in various industries. One of these features is the radiopacity which results from the addition of the heavy metal component. When Bi (or W) are used as the heavy metal component, the radiopacity of the high-density material can be comparable to a lead sheet. Another of these features is the density, which can range from about 2 to about 6 g/cm³. In some embodiments, the density of the 3D printed products can range from about 2.7 to about 4.0 g/cm³. As well, the high-density 3D printed products can be produced in much less time than similar products made by injection molding. Where similar products are made by injection molding, the processes can take about 3-4 months to make a mold and fabricate the products. Using the methods described in this application, though, the products can be made in one week or less. Indeed, in some of these methods, the products can be made in 1-2 days, and even in 1-2 hours.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation, and use may be made without departing from the principles and concepts set forth herein. Also, as used herein, the examples and embodiments, in all respects, are meant to be illustrative only and should not be construed to be limiting in any manner.

1. A method for making a high density compound for use in a 3D printer, the method comprising:
providing a thermoplastic material;
providing a source of heavy metal; and
compounding the thermoplastic material and the heavy metal source to form a high-density compound with a density greater than about 2 g/cm³; and
extruding the compound to form filaments.

2. The method of claim 1, wherein the thermoplastic material comprises ABS.

3. The method of claim 1, wherein the heavy metal is bismuth, iodine, barium, tin, tantalum, cesium, antimony, gold, or tungsten.

4. The method of claim 1, wherein the heavy metal is Bi or W.

5. The method of claim 1, wherein the heavy metal source comprises Bi₂O₃ or W powder.

6. The method of claim 1, wherein the compound contains about 22 to about 30 wt % thermoplastic material and about 70 to about 78 wt % heavy metal.

7. The method of claim 1, wherein the density of the filament ranges from about 2 to about 6 g/cm³.

8. A method for making a 3D printed product, the method comprising:
providing a thermoplastic material;
providing a source of heavy metal; and
compounding the thermoplastic material and the heavy metal source to form a compound with a high-density;
extruding the high-density compound to form a filament;
melting the filament in the printing head of a 3D printer; and
depositing the molten material in a 3D printer in successive layers to form a 3D printed product.

9. The method of claim 8, wherein the thermoplastic material comprises ABS.

10. The method of claim 8, wherein the heavy metal is bismuth, iodine, barium, tin, tantalum, cesium, antimony, gold, or tungsten.

11. The method of claim 8, wherein the heavy metal is Bi or W.

12. The method of claim 8, wherein the heavy metal source comprises Bi₂O₃ or W powder.

13. The method of claim 8, wherein the compound contains about 22 to about 30 wt % thermoplastic material and about 70 to about 78 wt % heavy metal.

14. The method of claim 8, wherein the density of the 3D printed product ranges from about 2.5 to about 6.0 g/cm³.

15. The method of claim 8, wherein the density of the 3D printed product ranges from about 2.7 to about 4.0 g/cm³.

16. A filament for use in a 3D printer, comprising:
thermoplastic material in an amount ranging about 22 to about 30 wt %; and
a heavy metal in an amount ranging from about 70 to about 79 wt %;
wherein the filament has a density greater than about 2 g/cm³.

17. The filament of claim 16, wherein the filament has a density ranging from about 2 to about 6 g/cm³.

18. The filament of claim 16, wherein the thermoplastic material is ABS and the heavy metal is bismuth, iodine, barium, tin, tantalum, cesium, antimony, gold, or tungsten.

19. A 3D printed product made by the method comprising:
providing a thermoplastic material;
providing a source of heavy metal; and
compounding the thermoplastic material and the heavy metal source to form a compound with a high-density;
extruding the high-density compound to form a filament;
melting the filament in the printing head of a 3D printer; and
depositing the molten material in a 3D printer in successive layers to form a 3D printed product.

20. The product of claim 19, wherein the thermoplastic material comprises ABS.

21. The product of claim 19, wherein the heavy metal is bismuth, iodine, barium, tin, tantalum, cesium, antimony, gold, or tungsten.

22. The product of claim 19, wherein the heavy metal is Bi or W.

23. The product of claim 19, wherein the heavy metal source comprises Bi₂O₃ or W powder.

24. The product of claim 19, wherein the compound contains about 22 to about 30 wt % thermoplastic material and about 70 to about 78 wt % heavy metal.

25. The product of claim 19, wherein the density of the 3D printed product ranges from about 2 to about 6 g/cm³.

26. The product of claim 19, wherein the density of the 3D printed product ranges from about 2.7 to about 4.0 g/cm³.
